(19) United States
(12) Patent Application Publication
(10) Pub. No.: US 2016/0321680 A1
(43) Pub. Date: Nov. 3, 2016

(54) DATA INTERPOLATION USING MATRIX COMPLETION

(71) Applicant: International Business Machines Corporation, Armonk, NY (US)

(72) Inventors: Aleksandr Y. Aravkin, Bronx, NY (US); Younghun Kim, White Plains, NY (US)

(21) Appl. No.: 14/861,761

(22) Filed: Sep. 22, 2015

Related U.S. Application Data
(60) Provisional application No. 62/153,776, filed on Apr. 28, 2015.

(51) Int. Cl. G06Q 30/02

(52) U.S. Cl. CPC G06Q 30/0201

(57) ABSTRACT

A method, system, and computer program product to obtain an interpolated matrix of customer data are described. The method includes generating a matrix identifying customers along a first axis and customer attributes along a second axis and entering initially available data into the matrix. The method also includes interpolating based on the initially available data to fill the matrix while imposing constraints on the interpolating. The method further includes using the matrix, after the matrix is filled, to manage asserts or target customers.

This application is a non-provisional application that claims priority to U.S. Provisional Application Ser. No. 62/153,776 filed Apr. 28, 2015, the disclosure of which is incorporated by reference herein in its entirety.

### BACKGROUND

The present invention relates to data interpolation, and more specifically, to data interpolation using matrix completion techniques.

Businesses wish to obtain data about customers for a number of different reasons. In industries such as the utility industry, banking, and retail, for example, detailed information about customers can help to meet demand and improve service as well as facilitate targeted advertising. Often, basic information (e.g., name, age) may be known about many customers while more detailed information (e.g., income, education level) may only be known for some customers based on a survey, for example.

### SUMMARY

Embodiments include a method, system, and computer program product of obtaining an interpolated matrix of customer data. The method includes generating a matrix identifying customers along a first axis and customer attributes along a second axis; entering initially available data into the matrix; interpolating based on the initially available data to fill the matrix; imposing constraints on the interpolating; and using the matrix, after the matrix is filled, to manage asserts or target customers.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a process flow of a method of obtaining an interpolated matrix of customer data according to embodiments;

FIG. 2 illustrates exemplary clustering based on geographical proximity according to an embodiment;

FIG. 3 illustrates customer attributes associated with direct banking and exemplary market statistics based constraints according to an embodiment; and

FIG. 4 shows an exemplary system to obtain an interpolated matrix of customer data according to embodiments.

### DETAILED DESCRIPTION

As noted above, basic (sparse) information may be available for many or even most of the customers of an industry (e.g., utility, banking, retail), but detailed (dense) information may only be available for some customers, such as customers who participated in a survey, for example. Embodiments of the systems and methods detailed herein relate to predicting additional data for customers for whom sparse information is available based on interpolating dense information available for other customers. As detailed below, a matrix is generated with customers along one axis (e.g., x axis) and different types of information (e.g., age, household income, education, type of residence) along another perpendicular axis (e.g., y axis). Because some of the customers have many or most of the types of information filled in, information about those customers may be used to interpolate that same information for other customers whose information is not available. Matrix completion techniques are used, as detailed below, with constraints imposed as further detailed. The constraints minimize the affect of any false information among the dense information used to interpolate the sparse information. For example, if one or more customers reported a higher income in a survey than they actually earn, the affect of that false income data on interpolated data or attributes is minimized through the constraints. The interpolation problem is cast as an optimization problem. Based on the (interpolated) matrix of information about customers, a number of actions may be taken in the corresponding industry. These actions include resource management and targeted advertising, for example.

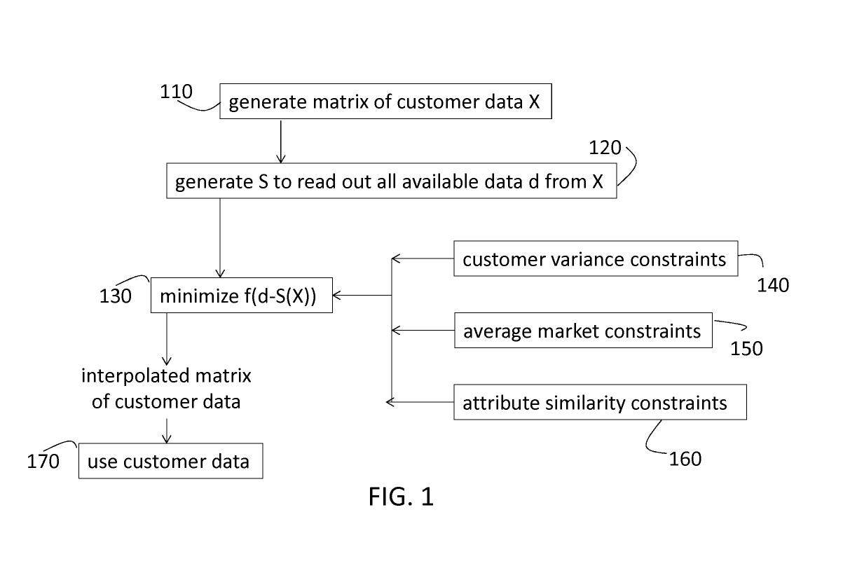

FIG. 1 is a process flow of a method of obtaining an interpolated matrix of customer data according to embodiments. At block 110, generating a matrix of customer data X includes arranging customers along one axis (e.g., in rows) and available attributes along another axis (e.g., in columns). The attributes may be continuous (e.g., salary, age, house size, location, frequency of shopping), binary (e.g., male, female), ordinal (e.g., education level, social class), or categorical (e.g., political affiliation, favorite grocery store, membership), for example. Initially available data d is used to initialize the matrix X. Generating S to read out data (initially d) from X, at block 120, includes using S as a mapper such that d=S(X). At block 130, minimizing f(d−S(X)) includes d (initially known data) remaining constant. Based on interpolation, X changes (more matrix cells are populated), but minimizing f(d−S(X)) means that the movement away from the initially known data d values is minimized. The function f may be a L−1 norm (least absolute deviation), a L−2 norm (least square deviation), a Huber loss function, or another known convex function, for example. The minimization model f may be a dynamic model that can address outliers. That is, some of the data d may be contaminated by outliers due to false reporting (e.g., a customer reports a higher income than he earns), for example. A robust model f can obtain a reasonable fit without trying to fit outlying observations. Three types of constraints (140, 150, 160) are imposed on the minimization model f. The customer variance constraints, at block 140, the average market constraints, at block 150, and the attribute similarity constraints, at block 160, are further detailed below. The result of the minimization with the imposition of the constraints is an interpolated matrix X (a completed matrix) of customer data. At block 170, using the customer data includes using data from this completed matrix X is not limited to any particular industry or application. For example, the matrix X may be used for targeted advertisements, for equipment management (to ensure that available equipment meets projected demand), or for infrastructure management.

Customer variance constraints (block 140) or customer diversity constraints are related to the premise that there may be underlying similarities among customers in the matrix X. Variance constraints may be expressed as:

g(X)≦t1 [EQ. 1]

In EQ. 1, t1 is a column vector indicating sample variance of each attribute. For example, t1 may include the sample variance of the income level of the entire population, the sample variance of the house size, and the sample variance of age, among sample variances of other attributes. The function g(X) is a convex function known as a nuclear norm. The function g(X) approximates a rank constraint imposed on X based on underlying similarities between customers in the matrix X. When a diverse set of customers is included in X, the sample variance for many attributes may be high (as compared with a less diverse set of customers). However, within a geographical region (e.g., city, community) the number of customers is more limited than the full set of customers in X, and the variance among customers may be more limited, at least with respect to certain attributes. Thus, a number of clusters may be developed from the customers in X based on the initially available customer data d. The sample variance of attributes for customers within a cluster would be less than the sample variance of attributes for all customers in X. The clusters may be viewed as a diversity index. The number of clusters into which customers in matrix X are organized must satisfy conflicting needs. On the one hand, when the clusters are used to target customers for a marketing campaign, for example, having too many clusters (and, thus, too few customers in each cluster) may be undesirable. On the other hand, having too few clusters may make clustering the customers meaningless. That is, when enough clusters are not developed, the sample variance among attributes for customers in a cluster and all customers in the matrix X may be similar. For example, when an unsupervised clustering technique (e.g., two-step approach) is applied to obtain the number of clusters in the interpolated matrix X, the variance constraint on the number of clusters obtained via the unsupervised clustering technique is given by:

min_diversity≦number−of−clusters(unsupervised−clustering)≦max_diversity [EQ. 2]

EQ. 2 shows the maximum and minimum number of the clusters the total population of customers in matrix X may be organized into. These minimum and maximum diversity numbers may be user defined, for example. In alternate embodiments, market statistics and other information may be used to determine the diversity range for the clusters. This additional constraint (of EQ. 2 in addition to EQ. 1) enforces the optimization algorithm (min(f(d−S(X)))) to have a desired number of population groups (clusters). For example, in a small community (e.g. 1000 people), the population groups or clusters for targeted marketing may be limited to 7-10 people so that the targeted marketing can be cost effective.

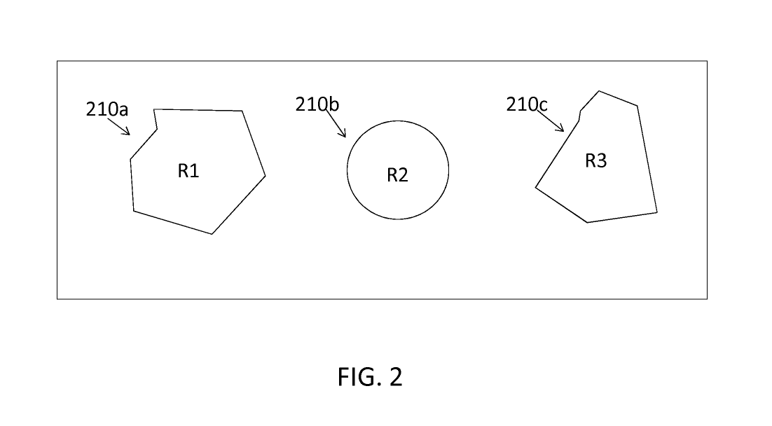

FIG. 2 illustrates exemplary clustering based on geographical proximity according to an embodiment. The attribute similarity constraint may be modeled by imposing structural constraints on sub-rows of matrix X (in the exemplary case of customers being arranged along rows of matrix X). That is, customers within the matrix X that reside in the same neighborhood may be found to share one or more attributes in common. Both political and polygonal boundaries may be used to confine diversity within the region. The diversity is defined as a total number of unique clusters which are the outcome of the optimization (of min(f(d−S(X)))). Thus, the customers in matrix X may be clustered according to their neighborhood or geographical regions 210. Each of the regions R1 210a, R2 210b, R3 210c shown in FIG. 2 represents a different clustering and has a different maximum diversity.

Average market constraints (block 150) are related to the premise that market statistics may be imposed on the interpolation of matrix X. The market constraints may be expressed as:

AX≦b [EQ. 3]

In EQ. 3, A is an aggregation matrix, and b defines the known market cap of each attribute. A defines a linear combination of the attributes of the entire population as market statistics. For example, in the exemplary case of customers being arranged in rows of matrix X, A is a row matrix, and each element of A represents a column (all customers' entries for a given attribute) in X. An element of A may be a sum of all entries associated with an attribute in matrix X. For example, an attribute in matrix X may be ownership of a smart car, and each entry in the column associated with this attribute (in matrix X) may be a 1 (ownership) or 0 (non-ownership). The entry in A associated with this attribute may be a sum of all the 1 and 0 entries in the matrix X. An element of A may be an average of all entries associated with an attribute in matrix X, as well. For example, an attribute in matrix X may be income. The entry in A associate with this attribute may be an average of all the entries in the matrix X. The market cap, b, constrains the interpolated values in matrix X. For example, based on b, the sum of a particular attribute may be limited to not exceed the value of the attribute for 20% of customers according to market statistics. Average market constraints are related to the fact that summaries of each attribute may be known from other sources. For example, 30% of all customers may be environmentally conscious. This information may be imposed as an affine constraint on X according to EQ. 3, which is an affine (known, vector-valued) function. This affine map provides flexibility in terms of defining various market statistics as described above. Generally, market statistics may be available for many types of information (e.g., distribution of age, market share, and donation amount). These market statistics translate into a set of statistics for each customer attribute (e.g., age, household income, investable assets). The set of statistics for customer attributes which may be imposed as constraints on the interpolation to fill matrix X. The set of constraints may be in the form on inequality constraints. For example

|sum−of−donation−amounts|≦total−donation−amount+error_bound [EQ. 4]

market−share−count|≦market−share+error_bound [EQ. 5]

The example shown by EQ. 4 is that the sum of all donation amounts in matrix X must be no greater than the (known) total donation amount for all of a population (e.g., Americans) associated with market statistics, with a margin of error. The margin of error (error bound) results from the fact that most market statistics are determined within +/−some value. The example shown in EQ. 5 indicates that the market share of all customers in matrix X cannot be greater than the market share of all people associated with market statistics, within a margin of error. This is further explained through an example shown in FIG. 2 below.

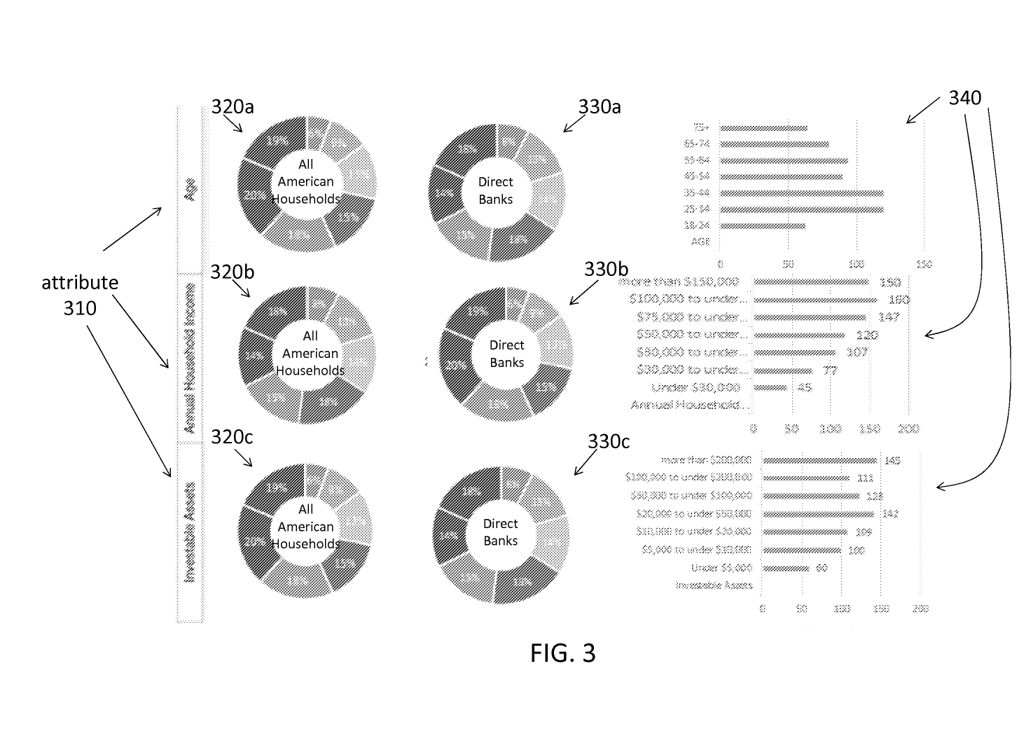

FIG. 3 illustrates customer attributes associated with direct banking and exemplary market statistics based constraints according to an embodiment. The exemplary attributes 310 shown in FIG. 3 are age, annual household income, and investable assets. The statistics for these attributes developed from market statistics, shown as statistics 320 for all American households, are used as constraints in determining customer attributes 330 related to direct banking For example, the same ratio of age distribution shown according to statistics 320a for all American households is imposed on the age distribution 330a of direct banking customers. The index 340 indicates values associated with the illustrated color coding related to each percentage.

Attribute similarity constraints (block 160) are related to the premise that some attributes are highly correlated. For example, higher education levels may correlate with higher electric vehicle ownership or higher income, or higher incomes levels may correlate with higher donations amounts. This correlation may be expressed as:

k(X)≦t2 [EQ. 6]

In EQ. 6, the correlation function, k(X), maps correlation among attributes in the matrix X. Information from market surveys, represented by t2, bounds the correlation. The market survey information indicating correlation among attributes may be quantified as a correlation score. The function k may be a correlation function between attributes or a covariance matrix in multiple-input cases. Multiple-input cases refer to correlation among multiple attributes (e.g., higher income correlates more closely with patronage of Whole Foods and with higher education).

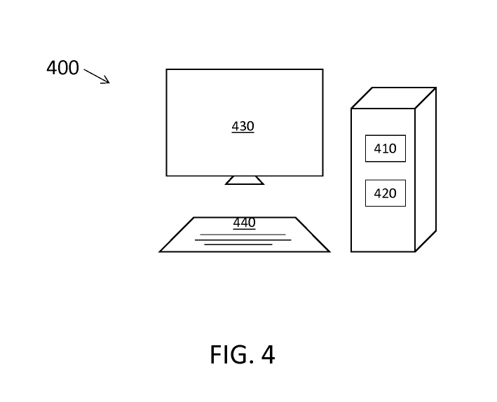

FIG. 4 shows an exemplary system 400 to obtain an interpolated matrix of customer data according to embodiments. The exemplary system 400 includes one or more memory devices 410 that store instructions and data, and one or more processors 420 that implement the stored instructions and other inputs. The exemplary system 400 may also include input interfaces 440 (e.g., keyboard) and output interfaces 430 (e.g., display device). The interfaces may facilitate communication (e.g., wireless communication) with other systems and databases, for example. The interfaces may be used to obtain inputs for the initially available data d and for the constraints used in the interpolation optimization discussed above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-7. (canceled)

8. A system to obtain an interpolated matrix of customer data to manage assets or target customers, the system comprising:
a memory device configured to store initially available data; and
a processor configured to generate a matrix identifying customers along a first axis and customer attributes along a second axis, enter the initially available data into the matrix, interpolate, based on the initially available data, to fill the matrix, and impose constraints on the interpolation.

9. The system according to claim 8, further comprising an interface to receive information about surveys and market research, wherein the processor generates the initially available data from the surveys and the market research.

10. The system according to claim 8, wherein the processor interpolates by minimizing f(d−S(X)), where d is the initially available data, X is the matrix, S is a read-out of values in the matrix X, and f is an interpolation function.

11. The system according to claim 10, wherein f is a convex function including at least one of a least absolute deviation L−1 norm, a least square deviation L−2 norm, and a Huber loss function.

12. The system according to claim 8, wherein the processor imposes constraints that include one or more of customer variance constraints, average market constraints, and attribute similarity constraints.

13. The system according to claim 12, wherein the processor imposes the customer variance constraints by imposing
g(X)≦t1, where
g(X) is a convex function that approximates a rank constraint and t1 is a column vector indicating sample variance of each of the customer attributes.

14. The system according to claim 12, wherein the processor imposes the average market constraints by imposing
AX≦b, where
A is an aggregation matrix, X is the matrix, and b defines known market caps for each of the customer attributes.

15. The system according to claim 12, wherein the processor imposes the attribute similarity constraints by imposing
k(X)≦t2, where
k is a correlation function or a covariance matrix that maps a correlation among the customer attributes, X is the matrix, and t2 represents information from market surveys.

16. A computer program product for obtaining an interpolated matrix of customer data, the computer program product comprising a computer readable storage medium having program instructions embodied therewith, the program instructions executable by a processor to perform a method comprising:
generating a matrix identifying customers along a first axis and customer attributes along a second axis;
entering initially available data into the matrix;
interpolating based on the initially available data to fill the matrix;
imposing constraints on the interpolating; and
using the matrix, after the matrix is filled, to manage assets or target customers.

17. The computer program product according to claim 16, wherein the interpolating includes minimizing f(d−S(X)), where d is the initially available data, X is the matrix, S is a read-out of values in the matrix X, and f is an interpolation function, and the imposing the constraints includes imposing one or more of customer variance constraints, average market constraints, and attribute similarity constraints.

18. The computer program product according to claim 17, wherein the imposing customer variance constraints includes imposing
g(X)≦t1, where
g(X) is a convex function that approximates a rank constraint and t1 is a column vector indicating sample variance of each of the customer attributes.

19. The computer program product according to claim 17, wherein the imposing the average market constraints includes imposing
AX≦b, where
A is an aggregation matrix, X is the matrix, and b defines known market caps for each of the customer attributes.

20. The computer program product according to claim 17, wherein the imposing the attribute similarity constraints includes imposing
k(X)≦t2, where
k is a correlation function or a covariance matrix that maps a correlation among the customer attributes, X is the matrix, and t2 represents information from market surveys.
